(19) United States
(12) Patent Application Publication
(10) Pub. No.: US 2026/0364619 A1
(43) Pub. Date: Nov. 19, 2026

(54) AEROSPIKE NOZZLE DESIGNS FOR COLD SPRAY SYSTEM IMPLEMENTATION

(71) Applicant: U.S. Army DEVCOM, Army Research Laboratory, Adelphi, MD (US)

(72) Inventors: Tristan W. Bacha, Egg Harbor City, NJ (US); John A. Dutcher, Milbury, MA (US); Isaac M. Nault, BelAir, MD (US); Michael B. Nicholas, Boxford, MA (US); Dennis J. Helfritch, Catonsville, MD (US)

(73) Assignee: U.S. Government, as Represented by the Secretary of the Army, Adelphi, MD (US)

(21) Appl. No.: 19/680,733

(22) Filed: May 18, 2026

Related U.S. Application Data
(60) Provisional application No. 63/808,343, filed on May 19, 2025.

(51) Int. Cl. B05B 7/14; B05B 7/00; C23C 24/04

(52) U.S. Cl. CPC B05B 7/1486; B05B 7/0075; C23C 24/04

(57) ABSTRACT

We present novel aerospike nozzle designs for cold spray deposition systems, offering a practical alternative to conventional converging-diverging nozzles. The key advantage of these designs is a significant resistance to clogging and wear, which are common issues when spraying materials such as aluminum and tin. The invention includes one-piece, two-piece, and three-piece configurations that are easily manufactured using methods like 3D printing or conventional machining and are adaptable to most commercial cold spray systems. The multi-piece designs allow for an adjustable nozzle throat size using shims or interchangeable components, enabling optimization of spray parameters. By isolating the cool powder-carrying gas from the hot process gas and nozzle walls until the exit, the design prevents material buildup and ensures reliable operation, even with challenging materials.

### RELATED APPLICATION DATA

This application claims the benefit of U.S. Provisional Patent Application No. 63/808,343, filed on May 19, 2025, which is herein incorporated by reference in its entirety for all purposes.

### GOVERNMENT INTEREST

The invention described herein may be manufactured, used and licensed by or for the U.S. Government.

### BACKGROUND OF THE INVENTION

The disclosure relates to cold spraying apparatus and nozzle improvements thereof.

### DESCRIPTION OF RELATED ART

Conventional cold spray nozzles accelerate particles through a converging-diverging nozzle where particles generally enter through a narrow throat region and are constrained to an area governed by the nozzle walls. In some cases, particles contact the nozzle wall and cause erosion or clogging, both of which are problematic.

Aerospike nozzles for cold spraying are an area of consideration. These designs, typically used in rocket engines, maintain high efficiency across a wide range of altitudes by using the surrounding air to shape the exhaust flow.

Rija Nirina Raoelison et al., in their paper, “A Concept of Aerospike Nozzle for Cold Spray Additive Manufacturing—Towards a Potential Solution for Preventing the Issue of Clogging,” Proceedings from the International Thermal Spray Conference, 2023, pp 229-234, proposed a conceptual design for an aerospike nozzle for cold spraying. It had a throat area of 0.053 in² (34.3 mm²). Using computational fluid dynamics (CFD), they compared their simulated aerospike nozzle design to a converging-diverging (CD) nozzle. They predicted particle velocities for 25 μm diameter aluminum particles at gas stagnation conditions of 435 psi, 350 °C: using their proposed aerospike design to be 554 m/s. The reported gas flow rates and power required to heat nitrogen gas to the stagnation condition for their aerospike nozzle were 7800 SLM (163 g/s) and 54 kW, respectively. We note that this power demand exceeds typical cold spray system specifications. For instance, the VRC Gen IV has a max power output of 24 kW. Moreover, their conceptual design gave no apparent thought to fabrication, thermal isolation, and other operational constraints. Thus, we believe their aerospike design is quite impractical for cold spray apparatus.

Improvements for aerospike nozzles for use in cold spraying apparatus are desired.

### SUMMARY OF INVENTION

This invention provides aerospike nozzles for cold spray apparatuses that offer significant advantages over conventional designs, primarily by reducing clogging and wear. The designs can be manufactured and implemented in commercial cold spray systems to deposit powders on various surfaces.

The invention may be provided for in several embodiments and configurations. A one-piece embodiment integrates a cowl and a central spike into a single, unitary body that can be produced efficiently through additive manufacturing. This design features a central passage through the spike for powder delivery and surrounding internal passages for hot process gas, which converge at a nozzle throat.

Multi-piece embodiments are also disclosed, including two-piece and three-piece designs. A two-piece version comprises a separate cowl and spike that can be assembled to form an adjustable gap, allowing the nozzle throat to be tuned using shims or by interchanging components. A three-piece version introduces a spike support body that aids in alignment and assembly. These multi-piece designs are well-suited for fabrication using conventional machining.

The aerospike nozzle designs isolate the powder-carrying gas from the hot nozzle walls until the point of particle acceleration, which is key to preventing material buildup and enabling the reliable deposition of challenging materials.

The embodiments and designs for the aerospike nozzles can be easily manufactured and implemented in commercial cold spray equipment to accelerate and deposit powders on various surfaces as an alternative to the typical converging-diverging nozzle (CD nozzle) used for depositing material. An aerospike nozzle accelerates particles in a high velocity gas stream that need not be constrained by nozzle walls.

The designs provide an advantage over CD nozzles for spraying materials that tend to clog, as the powder stream is isolated from the hot gas stream and nozzle walls that are prone to clogging. The general designs are resistant to clogging, and amenable to a range of geometry modifications for optimization of spray parameters and adaptation to most commercial cold spray systems. Various elements of the nozzles can be modified with a shim to provide different nozzle alignment configurations including changing the spike alignment and tuning the nozzle “throat” size. A one-piece design can be 3D printed, simplifying the manufacturing process. Unique features such as heat-breaks and injector tube nozzles can be incorporated in the design as described later for thermal isolation purposes.

A unifying inventive concept across all embodiments is the strategic thermal and physical isolation of the powder stream from the hot process gas and nozzle walls until the point of particle acceleration, which is achieved through a practical, manufacturable, and adaptable aerospike nozzle architecture.

The designs are also amenable to production by typical machining or grinding methods and metal-based additive manufacturing techniques, including powder bed fusion (or a combination thereof).

A method of depositing a material using a cold spray system is also provided for which includes introducing a hot process gas into one or more internal passages of an aerospike nozzle; and introducing a cool powder-carrying gas through a central passage of a spike, wherein the powder-carrying gas remains thermally isolated from the hot process gas until both exit the nozzle.

These and other embodiments of the invention are described in more detail, below.

### BRIEF DESCRIPTION OF THE DRAWINGS

FIGS. 1A-IC show a one-piece aerospike nozzle for cold spraying according to embodiments, where FIG. 1A is an isometric cross-sectional view; FIG. 1B is a rear view; and FIG. 1C is a side cross-sectional view.

FIGS. 2A-2E show two-piece aerospike nozzles for cold spraying according to embodiments, where FIG. 2A is a side cross-sectional view of one nozzle during assembly and FIG. 2B is the same view of that nozzle in the assembled state. FIG. 2C is a side cross-sectional view of an additional nozzle embodiment. FIGS. 2D and 2E show an alternative design for a two-piece aerospike nozzle for cold spraying according to embodiments, where FIG. 2D is a side cross-sectional view with a shim present and FIG. 2E is the same view with and without a shim.

FIGS. 3A-3D show a three-piece aerospike nozzle according to embodiments where FIG. 3A is an assembled view, where FIG. 3B is an exploded view, FIG. 3C is a front cross-sectional view, and FIG. 3D is an isometric view of the spike inserted within and the third piece body (without the cowl).

FIGS. 4A-4F show additional features relating to the aerospike nozzles according to further embodiments. FIG. 4A shows an injector tube which can be inserted into the spike body according to embodiments. FIG. 4B presents an exemplary embodiment for the multi-tube injector tube. FIG. 4C shows the injector tube further assembled in a thermal shield tube. FIG. 4D shows a side view of a spike body with an engineering front end according to an embodiment. FIG. 4E shows the front end of the spike portion in greater detail. FIG. 4F shows a multi-bore tapered injector tube. FIG. 4G shows a side view of a multi-walled thermal shield tube assembly according to an embodiment.

FIGS. 5A-5D show details of cold spray apparatus having an aerospike nozzle according to embodiments.

FIGS. 6A and 6B show key dimensions of the aerospike nozzle designs employed to engineer the novel nozzle embodiments presented herein, where FIG. 6A is a side cross-sectional view and FIG. 6B is a front cross-sectional view at the nozzle throat.

FIG. 7 is a plot showing combinations of spike/cowl gap dimensions for heating gas to 600 °C at 900 psi according to embodiments.

FIG. 8 shows the difference in gas flow characteristics of the novel aerospike nozzle and a conventional converging-diverging cold spraying gas nozzle.

### DETAILED DESCRIPTION

We present various embodiments and designs for aerospike nozzles suitable for installation into cold spray systems where the operating gases are split into a high temperature process gas, and a low temperature powder carrying gas. Single and multiple-piece designs are presented. The nozzle may be formed of any material with sufficient strength and thermal resistance for cold spray applications, including but not limited to high-temperature polymers, ceramics, metals, and metal alloys. These designs ensure alignment of the nozzle pieces which is critical for obtaining an annular region through which the main gas flows.

Powder injector tubes in the novel aerospikes nozzles may consist of multiple materials and are flexible in geometry. The injector tube may be made of a metal or ceramic, or a metal surrounded by an outer ceramic insulating sleeve. An insulating layer between the inner and outer tube may be incorporated to prevent high temperatures in the spike from transferring to the injector tube to prevent it from clogging. The gap may consist of stagnant air, active flow, a low conductivity material, or vacuum. Single or multi-bore tubing may be used for particle injection to achieve different powder injection characteristics.

A second nozzle section of constant area or some other geometry may be affixed to the end of an aerospike nozzle to improve spray performance. The nozzle section is preferably made of a material to which the powder does not adhere during spraying, and may be made of metal, plastic, ceramic, graphite, etc. Additionally, no clogging was observed at the maximum possible temperature the cold spray system can operate at. This condition typically results in clogging when conventional nozzles are used. Additional features such as cooling jackets and precision collets may be used to affix extension tubes to the aerospike nozzle.

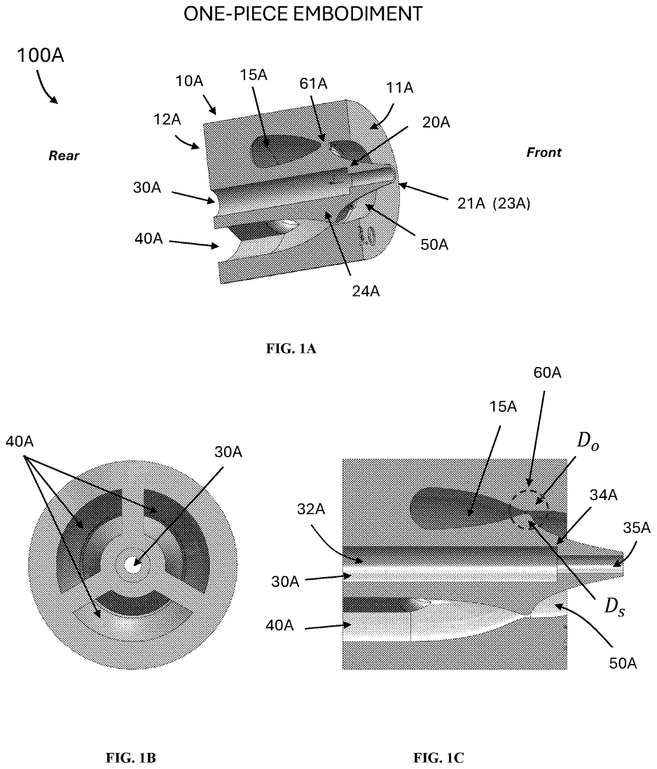

FIGS. 1A-1C show a one-piece aerospike nozzle 100A for cold spraying according to embodiments. While the term “one-piece” is used, it should be understood that this refers to a unitary body construction. The “one-piece” nozzle could be formed from multiple pieces that are joined together by methods such as soldering, welding, or adhesive to form the final unitary body. This does not include additional elements that may later connect with the nozzle in an assembled cold spray device.

The one-piece aerospike nozzle 100A includes a cowl (or body portion) 10A having a front 11A and a rear 12A and defining an internal space 15A within the cowl 10A that is open in the front 11A. The nozzle 100A also includes a spike 20A having a front 21A and extending from the rear of the cowl 12A into the internal space 15A and terminating at a tip 23A in the front 21A.

The spike 20A can have a body 24A which tapers down to the tip 23A. The taper could be linear or other taper shape (e.g., curved). The body 24A can have a bulbous (bulging) shape, as shown. For instance, spike diameters may be between ⅛″ and 1″.

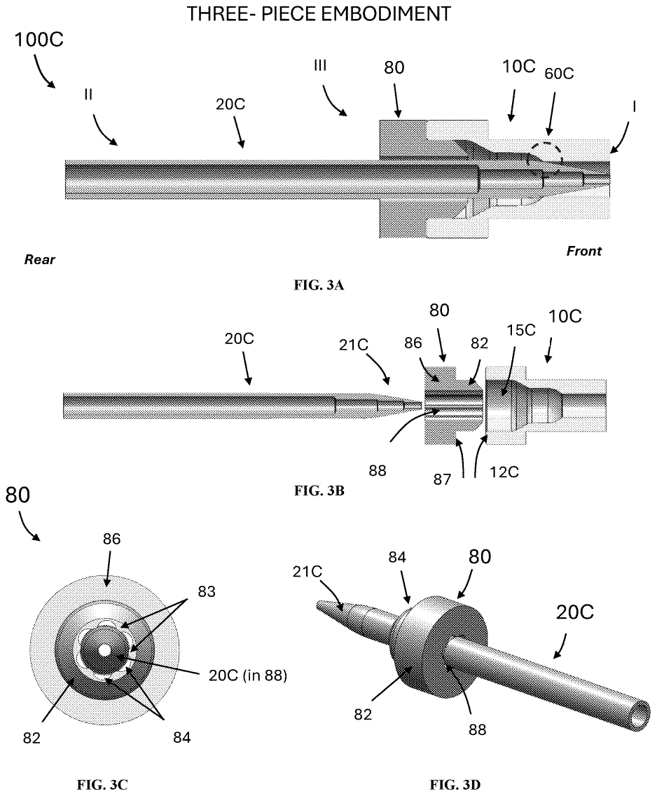

There is a central passage 30A that extends through the length of the spike 20A from the rear 12A of the cowl to the tip 23A. Cool powder carrier gas will be introduced in the central passage 30A from the rear, either directly or indirectly via an injector tube (see FIG. 3B) which can be inserted into that passage, and exit from the tip 23A.

One or more internal passages 40A are spaced around the central passage 30A extending from the rear 12A of the cowl into the internal space 15A. Hot process gas will be introduced into the internal passages 40A from the rear, and exit from the front.

A gap 50A exists between the outer surface of the spike 20A and the internal surface of the cowl in internal space 15A in the front. The inner diameter of the cowl 10A, D_{O}, and the outer diameter of the spike 20A, D_{S}, are determined at the smallest cross-sectional area formed in the annular area between the cowl 10A and the spike 20A. This is the nozzle “throat.” 60A. It is located in the gap 50A.

The hot process gas will flow through the internal space 15A passing through the gap 50A and throat 60A and exit near the front. The gap 50A may be configured to provide a converging section rear behind the throat 60A and a diverging section forward of the throat 60A. The dimensions are flexible and are constrained by available heater power available and the desired system pressure/temperature of operation. The annular gap should also be large enough so that minor misalignments between the cowl and the spike, for example, due to machining tolerances, do not result in large performance differences.

The nozzle 100A may be formed by additive manufacturing or 3D printing. For instance, the nozzle may be formed of polymer, such as polycarbonate or ABS, or a metal or alloy (e.g., steel, aluminum, or titanium), as non-limiting examples.

There may be 10s to 100s of equally spaced or asymmetrical internal passages 40A formed in the cowl 10A; of course, fewer can be provided (3 such passages are shown in FIG. 1). They would be constrained by the size of spike 20A. Such internal passages could be as small as 0.040″, as a non-limiting, and formed by drilling or additive manufacturing. In one arrangement, there is simply 1 internal passage which is asymmetrical positioned with respect to the central passage 30A. The central passage 30A may have a first diameter 32A from the rear to near the front, and a second smaller diameter 35A near front to the tip 23A. There is a step 34A where the first and second diameters come together. The step can be abrupt (as shown) or tapered. It can be used to engage the terminal end of an injection tube of a cold spraying apparatus. Multiple steps may be incorporated to achieve the final diameter reduction to accommodate the injector tube.

As shown, the tip 23A can extend past the front 11A of the cowl 10A. However, the tip 23A could be positioned within the internal space 15A within the cowl or flush with front surface 11A of the cowl. In some embodiments, for additional support, the spike 20A connects to the cowl at one or more locations 61A near the gap 50A (or throat 60A).

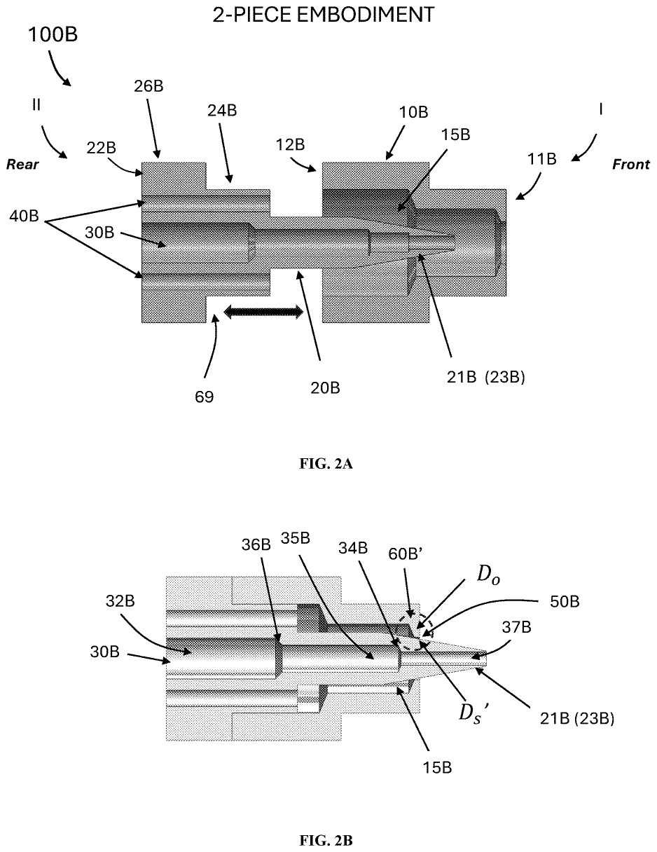

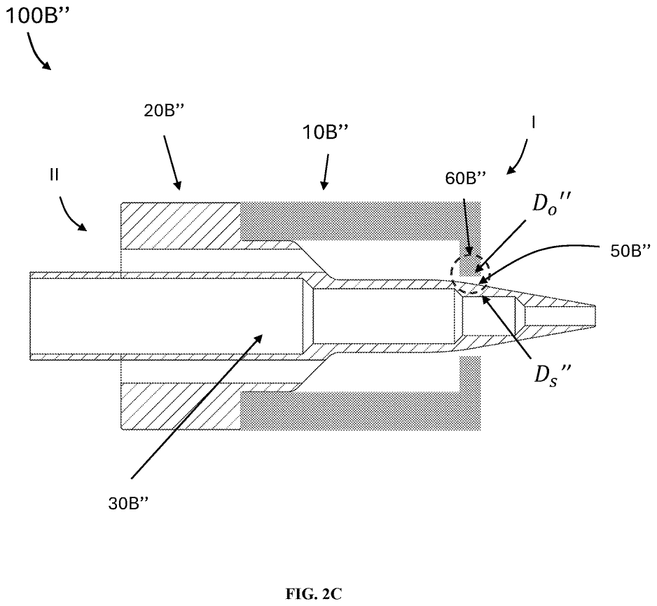

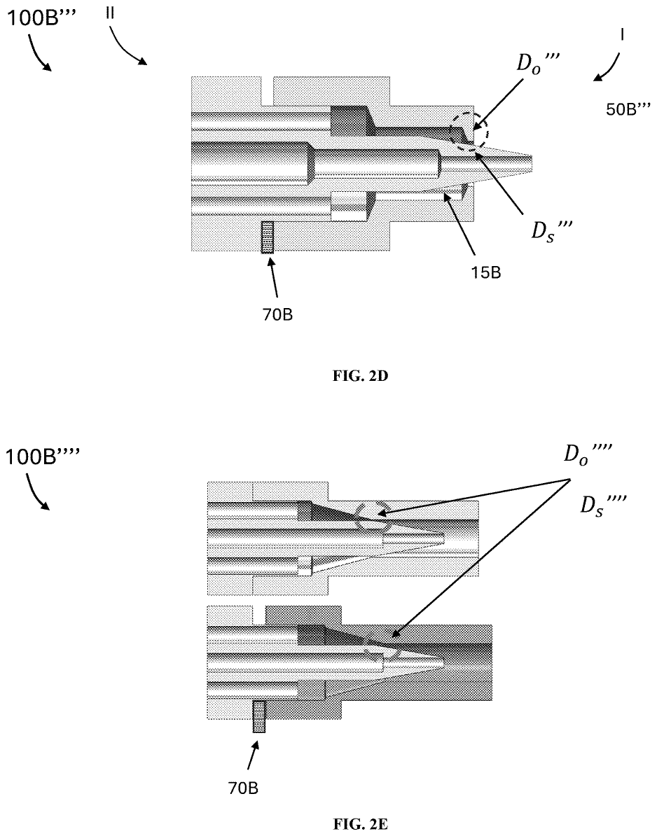

FIGS. 2A and 2B show a two-piece aerospike nozzle 100B for cold spraying according to embodiments. It is formed of a first piece I and a second piece II. FIG. 2C shows an alternative design for a two-piece aerospike nozzle 100B′ for cold spraying according to embodiments.

While we use the term “two-piece,” it should be appreciated that we mean a two-part body construction. The “two parts” could be formed of multiple pieces first which are joined together, such as by solder, welding or adhesive to the form the first and second pieces. This does not include additional elements that may later connect with the nozzle in an assembled cold spray device.

The first piece I includes a cowl (or body) 10B having a front 11B and a rear 12B and defining an internal space 15A within the cowl. The second piece II has a front 21B and a rear 22B. It is formed of a spike 20B having a tip 23B at the front 21B. A central passage 30B passing through the spike 20B from the rear to the tip 23B. One or more internal passages 40B are spaced around the central passage 30B. Cool powder carrier gas will be introduced in the central passage 30B from the rear, either directly or indirectly via an injector tube (see FIG. 3B) which can be inserted into that passage and exit from the tip 23B. Hot process gas will be introduced into the internal passages 40B from the rear and exit from the front.

The spike 20B of the second piece II is slidable into the internal space 15B of the first piece I to form an adjustable gap 50B between the outer surface of the spike and the internal surface of the internal space of the cowl in the front, and there is a throat 60B located in the gap at the closest distance between the cowl 10B and the spike 20B. The spike 20B is held aligned to be centered in the cowl 10B by a mating fit, where the spike is the male end and the cowl is the female. In some embodiments, mating surfaces of the cowl and spike are threaded. This permits piece II to screw into piece I.

In other embodiments, as shown in the assembled view in FIG. 2A, the rear of the second piece comprises a flange 26B which can abut the rear 12B of the first piece when inserted when the second piece is inserted into the first piece.

As shown in FIG. 2B, there is space 69 between the rear flange of the second piece and the rear of the first piece to adjust the gap 50B′ (and throat 60B′). In the embodiments shown in FIGS. 2C, the inner diameter of the cowl 10B, D_{O}, at the smallest cross-sectional area formed in the annular area between the cowl 10B and the spike 20B remains fixed. In some embodiments and implementations, a shim 70B can be inserted into space 69. With the shim 70B, the outer diameter of the spike 20A, D_{S}′, at the smallest cross-sectional area formed in the annular area between the cowl 10B and the spike 20B, changes to D_{S}″. The shim-adjusted gap 50B′ between the cowl 10B and the spike 20B increases in throat 60B″. FIG. 2D compares the size of the throat 60B″ with and without shim the 70B.

The first and second pieces I and II may be machined. They may be formed of metal or alloy, such as aluminum or steel. Higher temperature materials like stainless steel are preferred.

As shown, the central passage 30B has a first diameter portion 32B from the rear to near the front, and a second smaller diameter portion 37B near to the tip 23B. In some arrangements, there may be at least one other larger diameter 35B than the first diameter with diameters decreasing in size from the rear to the front. Steps 34B and 36B are when the diameters change.

The tip 23B can extend past the front of the cowl 10B. However, the tip 23B could be positioned within the internal space 15B within the cowl or flush with front surface 11B of the cowl. The cowl 10B may have a first inner diameter near the rear and the inner surface of the cowl tapers inwardly to a second smaller inner diameter approaching, near, or at the front.

FIGS. 2A and 2B shows a cowl that tapers inward to form the throat. FIG. 2C shows an additional nozzle 100B″ embodiment having a contoured interior channel 30B″ in the spike 20B″ with reduction in diameter from left to right. The spike 20B″ slides into the cowl 10B″. The smallest inner diameter is at the nozzle tip and may contact or nearly contact an injector tube that is passed through it. This area is the coolest due to gas expansion. A reduction in diameter to this region that lies beyond the throat effectively controls the heat input to the injector tube, minimizing the risk of a clog. The gradual reduction in inner diameter may be achieved by step-drilling. This eliminates contact between the injector tube and the spike walls to reduce heat transfer to the injector tube.

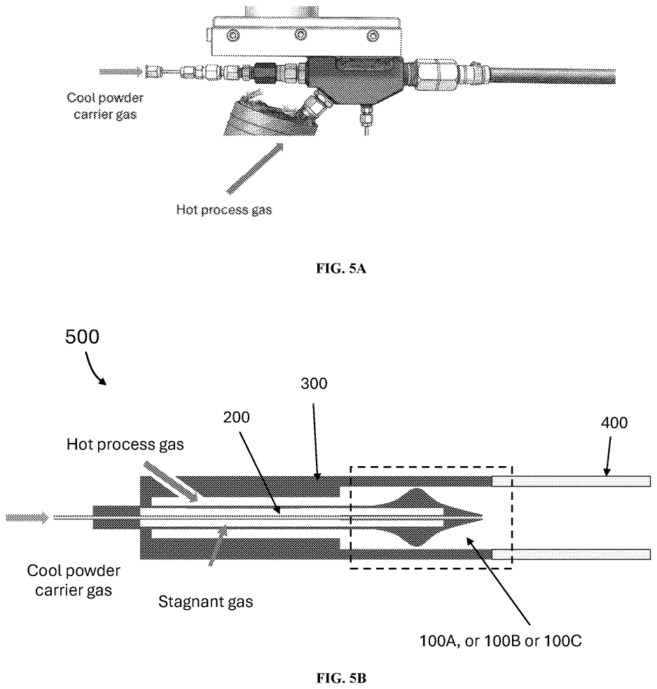

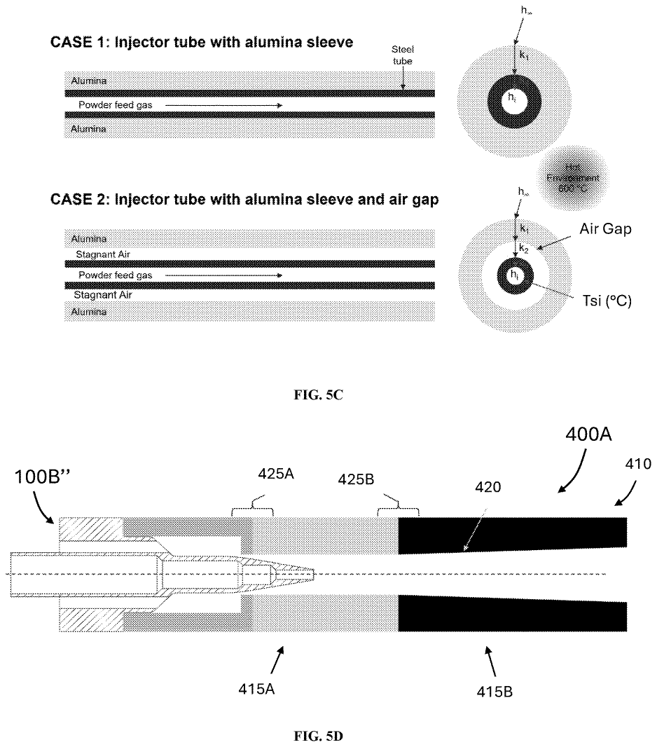

In FIGS. 2D and 2E, the cowl leads to a straight section. This design is amenable to adding an extension tube (see FIG. 5B). In some embodiments, a set of cowls and spikes of different dimensions (e.g., 10B″′, 10″″ and 20″′, 20″″) can be interchanged to change the gap dimensions between the spike and the cowl (e.g., D_{S}″′ D_{S}″″ and D_{O}″′, D_{O}″″), providing different area ratios of the aerospike nozzle. Similarly, with shims 70B of different thickness (as in a set), a similar effect can be achieved. In some embodiments, a set of cowls and spikes of different dimensions, which can be interchanged to change the gap between the spike and the cowl, providing different area ratios of the aerospike nozzle.

FIGS. 3A-3D show a 3 piece aerospike nozzle 100C according to embodiments. FIG. 3A is an assembled view, where FIG. 3B is an exploded view, FIG. 3C is a front cross-sectional view, and FIG. 3D is an isometric view of the spike inserted within and the third piece body (without the cowl).

While we use the term “three-piece,” it should be appreciated that we mean a three-part body construction. The “three parts” could be formed of multiple pieces first which are joined together, such as by solder, welding or adhesive to form the three pieces. This does not include additional elements that may later connect with the nozzle in an assembled cold spray device.

The three-piece nozzle 100C further modifies the two-piece nozzle embodiments, having a first piece I and a second piece II, to introduce a third piece III, which we refer to as a spike support. This construction helps reduce the need for sealing of the spike to a shield tube by splitting nozzle into 3 pieces. The area that would ordinarily need to be sealed between the spike and shield tube is eliminated and is replaced with the spike support III. The spike 20C is inserted into the spike support III which is inserted into the cowl 10C. The spike 20C has a tapered front end 21C to assist in proper location and to assist inserting in the axial direction to form the throat 60C. The spike support III includes a body portion 80 formed of narrow portion 82 for inserting into the internal space 15C of the cowl 10C and an enlarged portion 86. The narrow portion 82 includes contact sites 83 that help support the spike 20C and provides spaces 84 between the contact sites 83 which allow the hot process gas flow. The front of the enlarged portion 86 provides a flange surface 87 for abutting the rear surface 12C of the cowl 10C. Like for the two-piece embodiments (see FIG. 2B), different sizes shims can be placed between surfaces 12C and 87 to make an adjustable throat 60C (defining the gap). The body 80 also includes a bore 88 for receiving the inserted spike 20C. The spike 20C may be press fit into the bore 88 to provide a tight fit. The other features of the nozzle 100B are otherwise retained.

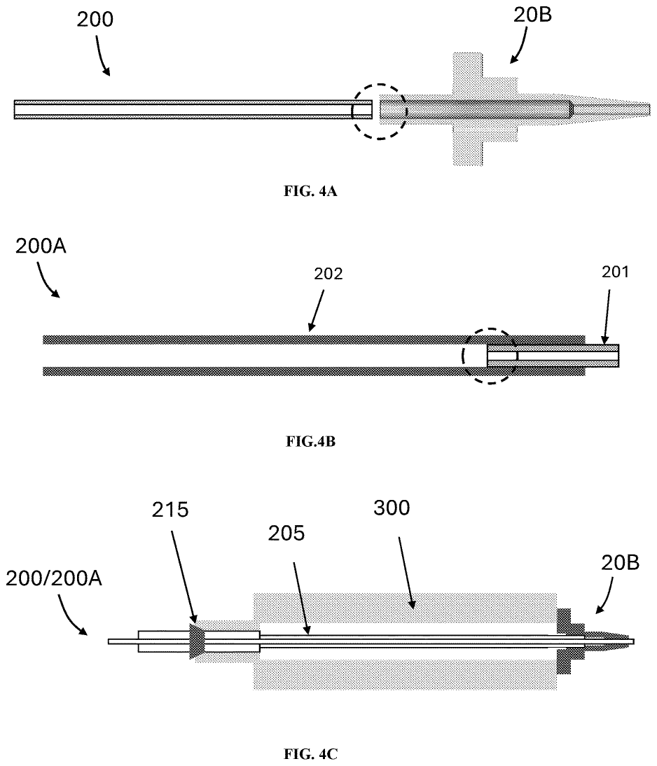

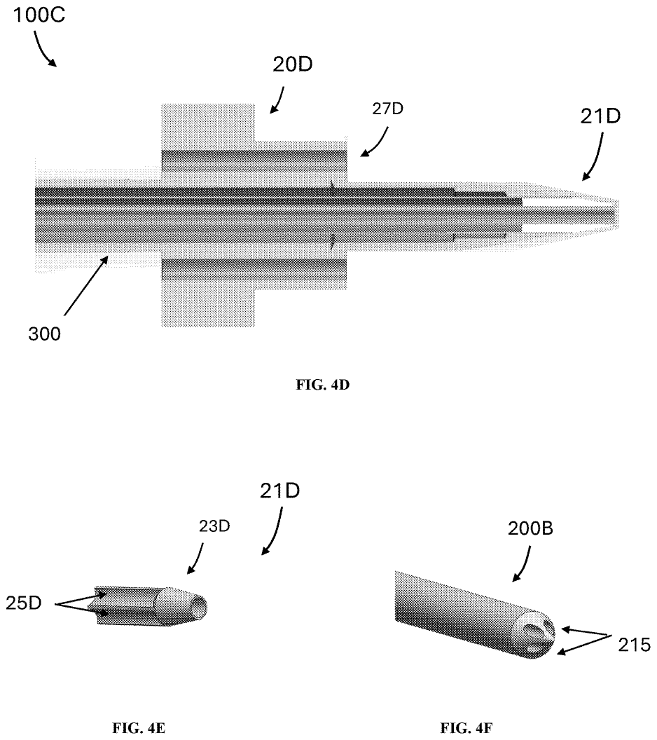

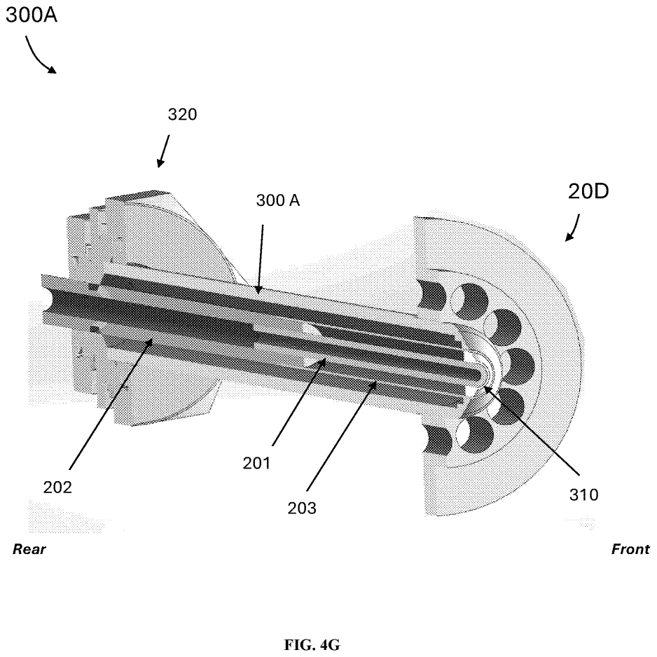

FIGS. 4A-4F show additional features relating to the aerospike nozzles according to further embodiments. FIG. 4A shows an injector tube 200 which can be inserted into spike body 20B according to embodiments. The injector tube 200 can help insulate heat from the hot process gases from reaching the cool powder injected. The insulating tube may be assembled and sealed to the spike body by a weld, press fit, cold spray, brazing, threading, press-fitting, etc. We have found that the seal area (circled) is susceptible to leakage, which can contribute to the injector tube clogging. Therefore, care should be taken to ensure a proper seal in this area. Moreover, we have found that this area is susceptible to material buildup over time, which can also lead to clogging.

So, as to further remedy this problem, FIG. 4B presents an exemplary embodiment for the multi-tube injector tube 200A. Here, a smaller tube 201 is inserted inside the tube 202 near where the nozzle will be located. The insert length may be shorter than the outer main tube 202 to form a step (circled). This arrangement minimizes the pressure drop and makes the injector tube 200A more resistant to fouling. Additionally, the inserted tube 201 functions as a liner provided better resistance to material adhesion. Both tubes 201 and 202 may be formed or metal, polymer, or ceramic, as a few non-limiting examples. The inserted tube 201 may be affixed within the tube 202 with high temperature adhesive, for example.

FIG. 4C shows injector tube 200/200A further assembled in a thermal shield tube 300. The thermal shield tube assembly 300 reduces heat transfer to the injector tube 200. The rear of spike is manufactured with additional material to provide options for sealing. The back-end can be sealed with high-temperature removable ferrule 215.

FIG. 4D shows a side view of a spike body 20D according to an embodiment. The spike body 20D can include a front end 21D with an engineering tip 23D designed to minimize conductive heat transfer. The front end 21D can be removeable or could be permanently attached when fabrication spike body 20D. FIG. 4E shows the front end 21D of the spike portion in greater detail. The tip 23D has a plurality of sidewall features 25D, which may be scalloped shaped (as shown), that reduces contact between the injector tip and spike body. These features 25D also minimize conductive heat transfer to the powder injector while keeping it centered in the spike body. The scalloped features further provide space for fluid flow to exit through the tip if active cooling in the air space is used for injector temperature control. The spike body 20D can be step-drilled to have a plurality of holes 27D to provide additional barriers to heat transfer. Similar to the embodiment in FIG. 2C, contact with the injector tube is limited to the spike tip, where spike temperatures are the lowest.

FIG. 4F shows an injector tube 200B which can be a multi-bore tapered injector tube which can be used in embodiments. The additional holes/bores 215 at the front can assist with particle dispersion and prevent clogging. The tip of which can be ground to a point to blend with the aerospike nozzle. Such tubes are commercially available in various materials.

FIG. 4G shows a side view of a multi-walled thermal shield tube assembly 300A according to an embodiment. The multi-walled thermal shield tube assembly 300A connects to the spike body 20D. The powder particles flow from the rear to the front. Fittings 320 for connecting and sealing the thermal shield tube assembly 300A to the “applicator” portion of the cold spray apparatus are also depicted. Heat transfer to the injector tube must be reduced to lower the probability of clogging. The assembly 300A is formed of multiple tubes 201, 202, and 203, at least partially concentrically arranged to minimize inner diameter injector length, reduce flow-driving pressure requirements, or both. Three tubes are shown here, although additional tubes may be provided for greater thermal isolation in other embodiments. The spike body 20D can be step-drilled to provide additional barriers to heat transfer. The tube assembly may connect to the spike with a seal 310 formed on a low thermal conductivity material, such as a ceramic (e.g., Macor).

FIGS. 5A-5D show details of cold spray apparatus having an aerospike nozzle according to embodiments. FIG. 5A shows a cold spray apparatus which can include the one-piece aerospike nozzle 100A, the two-piece aerospike nozzle 100B, or the three-piece aerospike nozzle 100C. FIG. 5B is a side cross-sectional schematic view of the “gun” of the cold spray apparatus 500. An injector tube 200 may be inserted from the rear and connected to the second diameter portions of the central passage 30A/30B in the front. We note, a practical outer diameter size limit of the injector tube is about of 1/32″-⅛″; the inner diameter could be as small as 0.005″ (i.e., on the order of the powder particles). The injector tube 200 may be a hollow tube formed of metal (e.g., steel), ceramic (e.g., alumina of ~0.002″) or glass. It could be 3″ long, as a non-limiting example.

Cool powder in a carrier gas is fed from the rear to the injector tube via a connection to a source of powder and cool carrier gas for supply of the same. The flow of the powder feed gas is generally highly turbulent flow. It might be 200 SLM of room temperature gas flowing at the speed of sound. Hot process gases are fed to the internal passages 40A/40B via a connection to a source of hot process gas (e.g., He or N₂, 600 °C at 900 psi) for supply of the same to the internal passages.

The cold spray apparatus may further include a thermal shield tube assembly 300 within the spray gun. The shield tube 210 reduces heat transfer to the injector tube 200. In addition, the cold spray apparatus may further include an extension tube 400 which attaches (e.g., with a collet) to the front of the cowl. For instance, the extension tube 400 could be a borosilicate glass tube attached to the aerospike nozzle cowl with an aluminum adapter. Glass was adhered to aluminum with a JB Weld to provide a permanent connection. In other embodiments, a collet may be used to releasably secure the extension tube to the end of the cowl (see FIG. 5A). We found polybenzimidazole and alumina extension tubes were also successful. The extension tube in conjunction with an aerospike nozzle was able to produce deposits with good material deposition rates. We manufactured a prototype nozzle made from borosilicate glass that enabled material deposition, which was not possible previously without the extension tube; the extension tube 400 may not be needed for the cold spray gun when using our novel nozzles. The extension tube 400 may be composed of a single material structure or formed of a composite structure.

As shown in FIG. 5C, the space (air gap) between the injector tube and the central passage at the rear can be filled with a stagnant insulating gas, a flowing cooling gas, or a low conductivity material (such as alumina), or is a vacuum. Case 1 shows the injector tube inside the nozzle with an alumina sleeve. And Case 2 shows the injector tube inside the nozzle with an alumina sleeve and air gap. This provides insulation of cool powder in a carrier gas from the heat of the hot process gases, preventing clogging of powder in the injector tube.

FIG. 5D shows one extension tube 400A embodiment. Here, it is shown connected to the nozzle 100B″ (FIG. 2C), but it could be connected to any of the nozzle embodiments. The extension tubes 400A can be formed as a composite structure 410 which incorporates two or more cooling jackets 415A, 415B to minimize wall temperatures and prevent clogging.

The jackets 415A, 415B may be made of metal, polymer, ceramic. From experimentation with the nozzle, it has been observed that any fouling in the extension tube happens at some point downstream from the spike tip. Generally, there are several inches of clean tube before any fouling is observed. An example arrangement may be a ceramic initial section, then the end section is made from polymer (polybenzimidazole, for example is a high temperature material commonly used in cold spray). In this arrangement, the polymer section can be used in sections where fouling occurs. Additionally, this polymer part will be in a relatively cool area of the nozzle assembly and therefore (potentially with the inclusion of an external cooling jacket) can also be used with processing temperatures that are traditionally too high to run polymer parts with.

The interior wall 420 of the external cooling jacket 415B has a slight taper which is for improving internal process gas flow characteristics. A practical angle for the taper may be between 0 and 5 degrees. The cooling jackets 415A, 415B can be connected to the nozzle 100B″ and each other by collets 425A, 425B, respectively. Collets are a simple joining method. Although, other joining methods may be used (e.g., welding, adhesive, threading, etc.) if the materials are amenable. For instance, a polymer/ceramic material combination will not be amenable to welding.

The nozzle 100A/100B/100C can be secured with a clamp holder having external threads and a nut having complementary internal threads. We note that there may be a clamping nut and body on the industrial cold spray systems, like the VRC gen III Cold Spray Unit, which can be used for this purpose.

These designs provide novel cold spray aerospike nozzles and detail possible design features for improvement, optimization, and adjustment of the aerospike. To date, we have produced multiple working prototypes of the nozzles in the laboratory. Both one-piece and multi-piece designs have been fabricated. Successful cold spray has been demonstrated for both. Our novel nozzle design concepts were designed to fit within cold spray “applicators” used on the VRC Gen III cold spray system. Dimensions for the current designs were chosen due to cold spray system flow limitations. The smallest cross-sectional area between the assembled spike and cowl is what limits the flow through the nozzle. However, design modifications may be made to adapt the ideas presented herein to various commercial cold spray systems.

To summarize, thus far:

Some key features and advantages for the one-piece design embodiments include:
1. A nozzle design can be manufactured using 3D printing technologies such as powder bed fusion combined with abrasive or chemical surface finishing
2. Heat-breaks may be included in the design to insulate the injector tube walls from the hot portion of the spike.
3. The inner surface of the injector tube can be formed into a smaller secondary, converging-diverging nozzle to accelerate particles to a higher velocity before they enter the primary aerospike nozzle flow.

Some key features and advantages for the two-piece design embodiments include:
1. The spike is centered within the cowl by a mating design
2. Adjustable spike-cowl gap with the use of shim between the “spike” and “cowl”
3. Spike and cowl can be manufactured using a conventional lathe and milling machine. More complex and optimized designs with curved geometries can be manufactured using CNC or metal 3D printing.
4. The spike can be interchanged with multiple cowls of different internal diameters to change the gap between the spike and the cowl, affecting different area ratios of the nozzle.
5. Different sized shims can be placed between surface of the spike and cowl to make an adjustable throat (defining the gap).

Some key features and advantages for the three-piece design embodiments include:
1. This construction introduces a separate body portion to reduce the need for sealing of the spike to a shield tube by splitting nozzle into three pieces.
2. The body also can assist in the assembly of the spike and cowl.
3. Like for the two-piece embodiments, different sizes shims can be placed between surfaces to make an adjustable throat (defining the gap).

Other “multi-piece” embodiments are further envisioned having additional pieces.

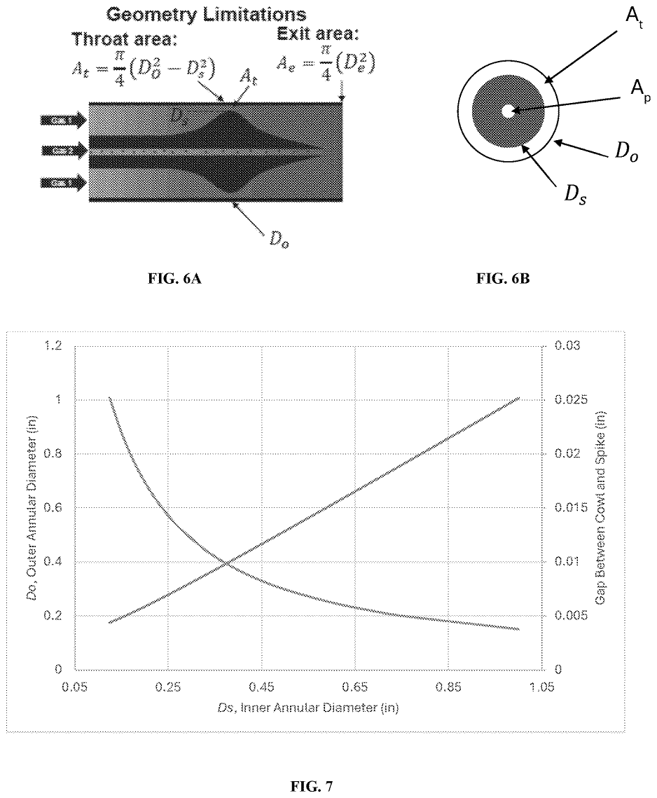

FIGS. 6A and 6B show key dimensions of the aerospike nozzle embodiments presented herein, where FIG. 6A is a side cross-sectional view and FIG. 6B is a front cross-sectional view at the nozzle throat. Those skilled in the art can use them to engineer and/or design the nozzle embodiments for specific applications.

The outer diameter of the spike body at the throat, Dₛ, and the inner diameter of the cowl at the throat, Dₒ, whether in the one-piece, two-piece, or three-piece embodiments, are determined at the smallest cross-sectional area formed in the annular area between the cowl and the spike. This is the nozzle “throat.” Aₜ is the annular area of the throat between spike and cowl (for hot gas). It is calculated as follows:

$${A}_{t} = \frac{π}{4} ( {D}_{o}^{2} - {D}_{s}^{2} ) \qquad ( 1 )$$

Some key parameters that determine the maximum possible throat area are:
Available heater power (\dot{Q})
Gas temperature
Gas pressure
Gas type (heat capacity, molecular weight, speed of sound)
Gas supply restrictions (typically <3000 SLM)

Gas pressure and temperature for high Mach number flow gas dynamics calculations are generally referred to as the “reservoir” temperature and pressure—a condition where the gas is not flowing. Generally, just upstream of the nozzle throat, the reservoir condition is not drastically different from the measured temperature and pressure if the cross-sectional area is much larger than the throat (that is, the flow is of low velocity).

The throat area can be designed for available heater power, gas type, temperature and pressure are known. Flowrate is a result of a given combination of throat area, temperature, and pressure. Higher pressures demand the most flowrate (e.g., 900-1000 psi are reasonable upper limits for industrial cold spray hardware), while flowrate decreases with increasing temperature.

Aₑ is the exit area based on the exit diameter, Dₑ, which may be provided downstream of the throat. It is calculated as follows:

$${A}_{e} = \frac{π}{4} ( {D}_{e}^{2} ) \qquad ( 2 )$$

Aₚ is the powder feed tube area. The flow is typically less than about 300 SLM; it is not limited by heater power. Other parameters include:
T_{R}—Reservoir temperature
P_{R}—Reservoir pressure
R—Ideal gas constant
γ—Ratio of specific heats
MW—Molecular weight
SLM—Gas flow rate in standard L/min
Cₚ—Heat capacity at constant pressure
T_{gas}—Temperature of heated gas (=Tt)
T_{ambient}—Temperature of gas to be heated

The major parameters dictating maximum throat area are the desired system pressure and temperature, and the power of the heater that is used.

From these parameters, various design equations for the nozzle can be calculated.

The Choked mass flowrate (\dot{m}) can be calculated as follows:

$$\dot{m} = \frac{{A}_{t} {P}_{R}}{\sqrt{{T}_{R}}} \sqrt{\frac{γ}{R}} {( \frac{γ + 1}{2} )}^{- \frac{γ + 1}{2 ( γ - 1 )}} \qquad ( 3 )$$

The molar flow rate (\dot{n}) is determined as follows:

$$\dot{n} = \frac{\dot{m}}{MW} \qquad ( 4 )$$

The choked gas flowrate (SLM) is determined as follows:

$$SLM = \dot{n} \times 22.4 ( \frac{L}{mol} @ STP ) \qquad ( 5 )$$

The power (\dot{Q}) of the spray is determined as follows:

$$\dot{Q} = {\dot{m}}_{{C}_{p}} Δ T = {\dot{m}}_{{C}_{p}} ( {T}_{R} - {T}_{ambient} ) \qquad ( 6 )$$

Combinations of D_{S} (spike diameter) and D_{O} (diameter of the cowl), and the corresponding gap distance between the outside of the spike and inside of the cowl at a gas temperature of 600 °C and pressure of 900 psi, assuming a power draw of 24 kW limited by the VRC cold spray system. We computed the maximum annular area in this case to be about 0.0065 in² (4.19 mm²). By contrast, we note that the simulation reported in the paper by Raoelison et al., mentioned above, had a throat area of 0.053 in² (34.3 mm²). This would require approximately 200 kW of power to achieve 600 °C at a pressure of 900 psi.

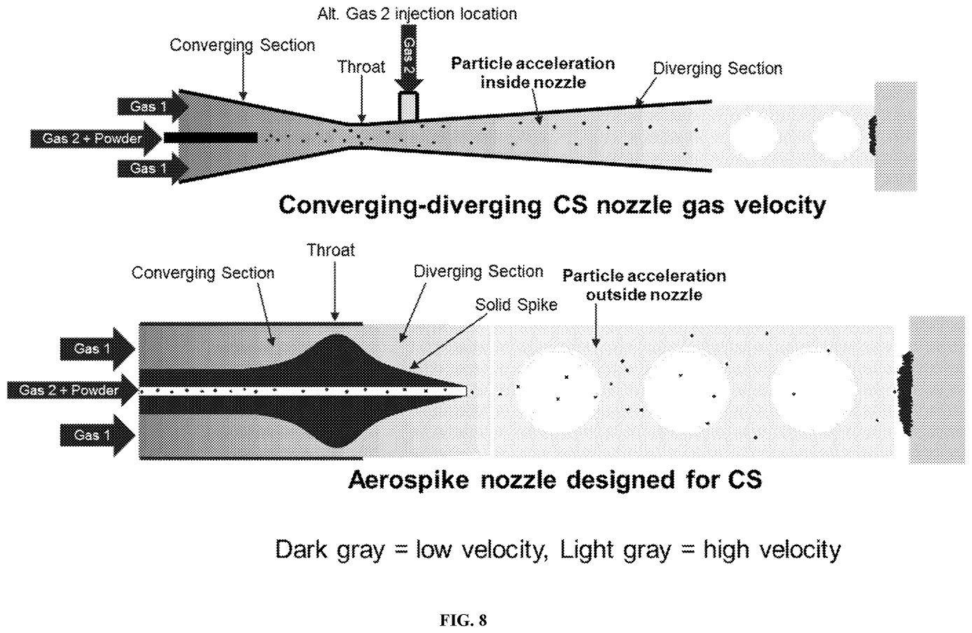

FIG. 7 is a plot showing combinations of spike/cowl gap dimensions for heating gas to 600 °C at 900 psi according to embodiments. Here, we presume an IMPACT GUN 6/11 AH Evo CSII can supply 44 kW of heating power. Practical spike diameters may be between ⅛″ and 1″. The annular area in this case was taken as 0.012 in² (7.67 mm²). Dimensions are flexible and are constrained by available heater power available and the desired system pressure/temperature of operation. The annular gap should also be large enough such that minor misalignments between the cowl and the spike do not result in large differences.

For instance, the one-piece aerospike nozzle 100A, the two-piece aerospike nozzle 100B, the three-piece aerospike nozzle 100C could be dimensioned as follows:
the spike having a forward narrowing taper to the tip (e.g., linear or non-linear)
the spike having an outer diameter between about 1/32-1 inch;
the inner diameter of the cowl at the throat, Dₒ, is between about 0.1-0.6 in.;
the outer diameter of the spike at the throat, Dₛ, is between about 0.1-0.5 in.;
the annular throat area is about 0.0065 in² (4.19 mm²); and/or
the throat between the cowl and spike is between about 0.004 to 0.018 in.

These values are non-limiting and other dimensions are certainly possible according to various embodiments.

FIG. 8 shows the difference in gas flow characteristics of the novel aerospike nozzle and a conventional converging-diverging cold spraying gas nozzle. In the conventional cold spray nozzles, there is extensive powder contact with nozzle walls. This leads to clogging in multiple areas of the nozzle and erosion of the nozzles (esp., when polymers are used in lieu of tungsten carbide (WC)). The novel aerospike nozzles, on the other hand, provide powder injection after the “throat.” There is limited powder contact with nozzle walls thus reducing or eliminating nozzle clogging. Thus, this enables a method of depositing a material using a cold spray system by introducing a hot process gas into one or more internal passages of an aerospike nozzle; and introducing a cool powder-carrying gas through a central passage of a spike, wherein the powder-carrying gas remains thermally isolated from the hot process gas until both exit the nozzle.

While the principles of this disclosure have been shown in various embodiments, many modifications of structure, arrangements, proportions, the elements, materials and components, used in practice, which are particularly adapted for a specific environment and operating requirements may be used without departing from the principles and scope of this disclosure. These and other changes or modifications are intended to be included within the scope of the present disclosure and may be expressed in the following claims.

The present disclosure has been described with reference to various embodiments. However, one of ordinary skill in the art appreciates that various modifications and changes can be made without departing from the scope of the present disclosure. Accordingly, the specification is to be regarded in an illustrative rather than a restrictive sense, and all such modifications are intended to be included within the scope of the present disclosure. Likewise, benefits, other advantages, and solutions to problems have been described above with regard to various embodiments. However, benefits, advantages, solutions to problems, and any element(s) that may cause any benefit, advantage, or solution to occur or become more pronounced are not to be construed as a critical, required, or essential feature or element of any or all the claims.

1. An aerospike nozzle for cold spraying comprising:
a cowl having a front and a rear and defining an internal space within the cowl that is open in the front;
a spike extending from the rear of the cowl into the internal space and terminating at a tip in the front;
a central passage extending through the spike from the rear of the cowl to the tip;
one or more internal passages spaced around the central passage extending from the rear of the cowl into the internal space; and
a gap between the outer surface of the spike and the internal surface of the cowl in internal space in the front, and there is a throat located at the closest distance between the cowl and the spike.

2. The aerospike nozzle of claim 1, wherein there are multiple internal passages formed in the cowl.

3. The aerospike nozzle of claim 1, wherein the central passage has a first diameter from the rear to near the front, and a second smaller diameter at the front.

4. The aerospike nozzle of claim 1, wherein the tip can extend past the front of the cowl.

5. The aerospike nozzle of claim 1, wherein the spike connects to the cowl at one or more locations near the gap or throat.

6. The aerospike nozzle of claim 1, wherein the gap comprises a converging section rear of the throat and a diverging section forward of the throat.

7. The aerospike nozzle of claim 1, wherein:
(i) the spike has a forward narrowing taper to the tip;
(ii) the spike has an outer diameter between about 1/32-1 inch;
(iii) the inner diameter of the cowl at the throat, Dₒ, is between about 0.1-0.6 in.;
(iv) the outer diameter of the spike at the throat, Dₛ, is between about 0.1-0.5 in.;
(v) the annular throat area is about 0.0065 in²; and/or
(vi) the throat between the cowl and spike is between about 0.004 to 0.018 in.

8. An aerospike nozzle for cold spraying comprising:
a first piece comprising a cowl having a front and a rear and defining an internal space within the cowl; and
a second piece having a front and a rear comprising:
a spike having a tip at the front;
a central passage passing through the spike from the rear to the tip; and
one or more internal passages spaced around the central passage,
wherein the first and second pieces are configured to be assembled such that the spike is positioned within the cowl to form a throat, and wherein the axial position of the spike relative to the cowl is adjustable to vary the dimension of the throat.

9. The aerospike nozzle of claim 8, wherein the rear of the second piece comprises a surface which can abut the rear of the first piece when the second piece is inserted into the first piece.

10. The aerospike nozzle of claim 9, wherein a shim can be inserted between the rear flange of the second piece and the rear of the first piece to adjust the gap.

11. The aerospike nozzle of claim 8, where the central passage has a first diameter portion from the rear to near the front, and a second smaller diameter portion near the front to the tip.

12. The aerospike nozzle of claim 11, where the central passage has at least one other larger diameter portion than the first diameter with diameters decreasing in size from the rear to the front.

13. The aerospike nozzle of claim 8, wherein the tip can extend past the front of the cowl when the second piece is inserted into the first piece.

14. The aerospike nozzle of claim 8, wherein the cowl has a first inner diameter near the rear and the inner surface of the cowl tapers inwardly to a second smaller inner diameter approaching, near, or at the front.

15. The aerospike nozzle of claim 8, wherein mating surfaces of the cowl and spike are threaded.

16. The aerospike nozzle of claim 8, wherein the gap comprises a converging section rear of the throat and a diverging section forward of the throat.

17. The aerospike nozzle of claim 8, wherein:
(i) the spike has a forward narrowing taper to the tip;
(ii) the spike has an outer diameter between about 1/32-1 inch;
(iii) the inner diameter of the cowl at the throat, Dₒ, is between about 0.1-0.6 in.;
(iv) the outer diameter of the spike at the throat, Dₛ, is between about 0.1-0.5 in.;
(v) the annular throat area is about 0.0065 in²; and/or
(vi) the throat between the cowl and spike is between about 0.004 to 0.018 in.

18. A set of cowls and spikes of different dimensions according to the aerospike nozzle of claim 8, which can be interchanged to change the gap between the spike and the cowl, providing different area ratios of the aerospike nozzle.

19. An aerospike nozzle for cold spraying comprising:
a first piece comprising a cowl having a front and a rear and defining an internal space within the cowl;
a second piece having a front and a rear comprising:
a spike having a tip at the front;
a central passage passing through the spike from the rear to the tip; and
one or more internal passages spaced around the central passage; and
a third piece comprising a body having a front and a rear comprising:
a narrow portion for insertion into the internal space of the cowl; and
an enlarged portion with surfaces for abutting the rear portion of the cowl; and
a bore for receiving the front of the spike,
wherein the first and second pieces are configured to be assembled with aid of the third piece such that the spike is positioned within the cowl to form a throat, and wherein the axial position of the spike relative to the cowl is adjustable to vary the dimension of the throat.

20. The aerospike nozzle of claim 19, wherein the narrow portion comprises a plurality of contact sites that help support the spike and spaces between the contact sites which allow gas to flow through.

21. The aerospike nozzle of claim 19, wherein:
(i) the spike has a forward narrowing taper to the tip;
(ii) the spike has an outer diameter between about 1/32-1 inch;
(iii) the inner diameter of the cowl at the throat, Dₒ, is between about 0.1-0.6 in.;
(iv) the outer diameter of the spike at the throat, Dₛ, is between about 0.1-0.5 in.;
(v) the annular throat area is about 0.0065 in²; and/or
(vi) the throat between the cowl and spike is between about 0.004 to 0.018 in.

22. The aerospike nozzle of claim 19, wherein a shim can be inserted between the front surface of the enlarged portion of the third piece and the rear of the first piece to adjust the gap.
